(19) United States
(12) Patent Application Publication
(10) Pub. No.: US 2009/0030537 A1
(43) Pub. Date: Jan. 29, 2009

(54) Interactive radio system and method

(76) Inventor: Allen Hartle, Bellevue, WA (US)

Correspondence Address: OLYMPIC PATENT WORKS PLLC;705 Second Ave., Suite 1111, P.O. Box 4277, Seattle, WA, 98194-0277, US

(21) Appl. No.: 12/077,726

(22) Filed: Mar. 19, 2008

Related U.S. Application Data
(60) Provisional application No. 60/918,946, filed on Mar. 19, 2007.

(51) Int. Cl. G06F 17/00

(52) U.S. Cl. 700/94

(57) ABSTRACT

An interactive radio system and method are disclosed. The system enables platforms, data solutions, and building community to deliver value for listeners, stations and advertisers. The system synchronizes the on-air activity of the radio station with websites, streaming audio, ecommerce systems, text messages and visuals and may include music, promotions and commercials. The system also distributes content identifiers with device makers (RDS/HD Radio receivers) so future radios can be designed to enhance user experiences.

### CROSS-REFERENCE TO RELATED APPLICATION

This application claims the benefit of Provisional Application No. 60/918,946, filed Mar. 19, 2007.

### FIELD OF THE INVENTION

The invention relates generally to a radio system and in particular to an interactive radio system and method.

### BACKGROUND OF THE INVENTION

Systems and methods exist that permit some level of interactivity between the consumer and the radio station. For example, there are a significant number of radio stations that list, on their web site, the currently played songs and then permit the user to buy the songs from the website. However, none of these existing system and methods permit a radio station to synchronize the on-air activity of the radio station with websites, streaming audio, ecommerce systems, text messages and visuals and may include music, promotions and commercials. Thus, it is desirable to provide a system and method that achieves this goal and it is to this end that the present invention is directed.

### BRIEF DESCRIPTION OF THE DRAWINGS

FIG. 1 illustrates an interactive radio method;

FIG. 2 illustrates an example of an implementation of the interactive radio system;

FIG. 3 illustrates two examples of media devices that include data from the interactive radio system;

FIG. 4 illustrates an example of a display aspect of the interactive radio system;

FIG. 5 illustrates an example of an elements aspect of the interactive radio system;

FIG. 6 illustrates an example of a mobile aspect of the interactive radio system;

FIG. 7 illustrates an example of an electronic program guide aspect of the interactive radio system;

FIG. 8 illustrates an example of a mobile media device that implements the interactive radio system; and

FIG. 9 illustrates the interactive radio system with the mobile media device.

### DETAILED DESCRIPTION OF AN EXEMPLARY EMBODIMENT

An interactive radio system and method is described that enables platforms, data solutions, and building community to deliver value for listeners, stations and advertisers. The interactive radio system synchronizes the on-air activities with websites, streaming audio, ecommerce systems, text messages and visuals and may include music, promotions and commercials. The system may also distribute content identifiers with device makers (RDS/HD Radio receivers) so future radios can be designed to enhance user experiences. Now, an example of an implementation and embodiment of an interactive radio system is described in more detail.

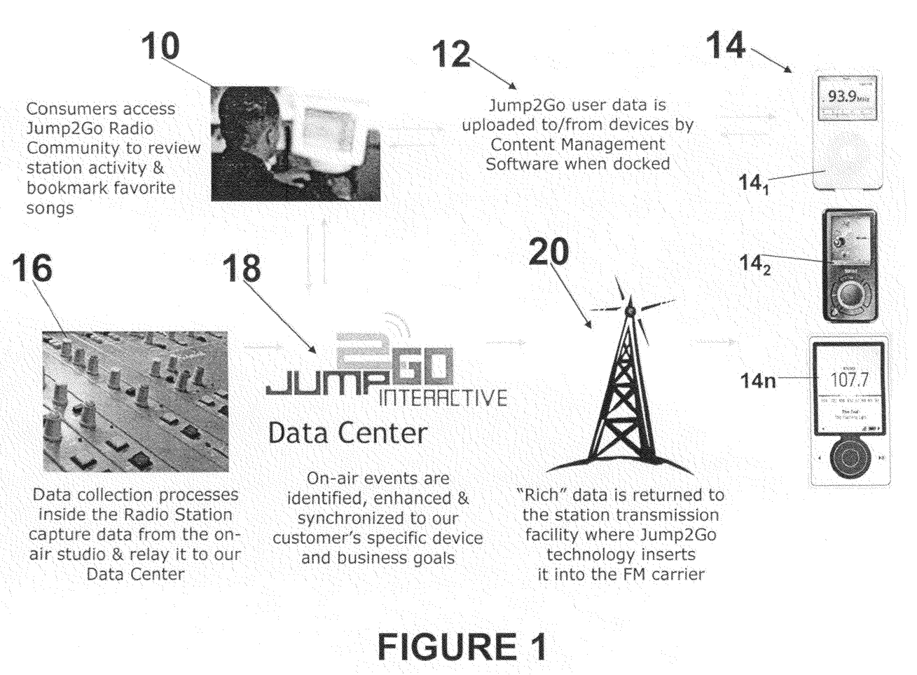

FIG. 1 illustrates an interactive radio method in which a consumer accesses an interactive radio community (implemented as a website in the exemplary embodiment) to review station activity and bookmark favorite songs (10). The data collected by the community associated with the user may be uploaded to/from a media device 14 by a piece of content management software when the media device is docked or a communication session is established with the media device (12). The media devices that may be used with the interactive radio system and method may include any device that is capable of displaying text or images and playing media content, such as a portable media device including an Apple® iPod 14₁, a Sansa media player 14₂ or a Microsoft® Zune device 14n. The devices may display the information associated with the interactive radio system (examples of the user interface are shown in FIG. 1) and may collect user feedback data that is then uploaded to the community. In the method, a data collection process (16) occurs inside the radio station to capture data from the on-air studio and relay it to a data center. The data center may then identify on-air events, enhance those on-air events and synchronize those on-air events to the particular device type of each consumer (so that the content being provided to each device is customized for that particular device) and the business goals of the merchant. Then, the data generated by the data center (display information that may be both textual and images, advertisements, promotions, etc.) are returned to the radio station transmitter (20) wherein an element of the interactive radio system inserts the data generated by the data center into the known RDS channel (in the FM carrier wave) so that the data is communicated to the devices 14. In this manner, the interactive radio system permits a radio station to interact with their consumers (as described below in more detail).

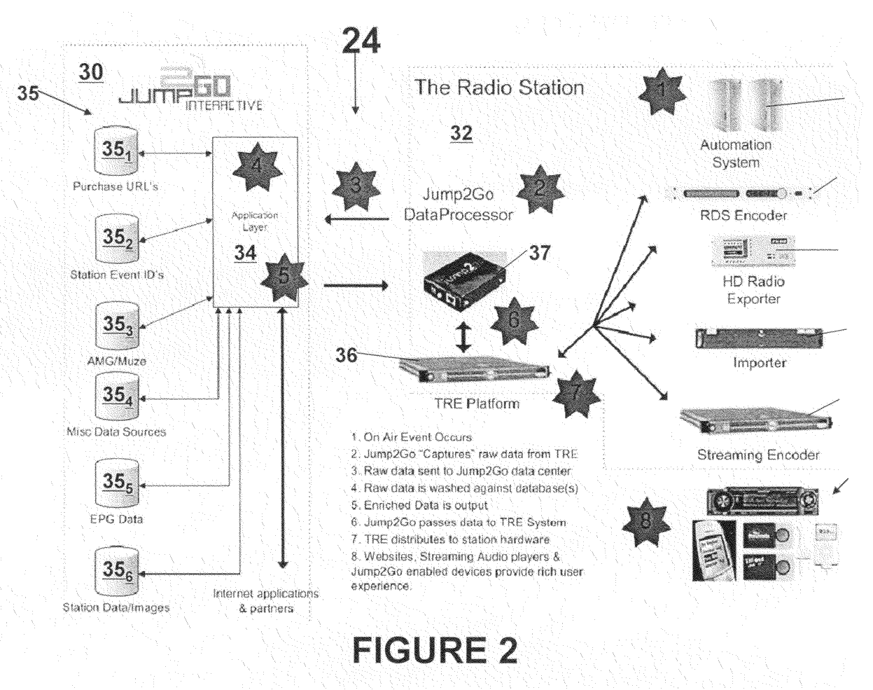

FIG. 2 illustrates an example of an implementation of the interactive radio system. A system 24 that incorporates an interactive radio system data center 30 and a radio station 32 that utilizes the interactive radio system is shown in FIG. 2 in which the interactive radio system 30 has elements that are physically located in the radio station, but are part of the interactive radio system. The interactive radio system may include an application layer 34 (one or more pieces of software executed by a processing unit of a computer system in an exemplary embodiment) that performs various operations of the system, one or more storage units 35, such as databases in the exemplary embodiment. The storage units of the interactive radio system may include, for example, a purchase URL store 35₁, a station event ID store 35₂, an AMG/Muze store 35₃, a set of miscellaneous data sources store 35₄, an electronic programming guide (EPG) store 35₅ and a station data and images store 35₆. The interactive radio system also may include a TRE platform 36 and a data processor device 37 which are both part of the interactive radio system, but physically located at the radio station location.

The radio station 32 may include an automation system 40 that permits the radio station to generate on-air events based on the programming, an RDS encoder 41 that encodes data onto the known RDS channel, an HD radio exporter 42 that exports data to HD radios, an importer 43 and a streaming encoder 44. In operation, an on-air event occurs (1) and the data processor 37 captures the raw data from the TRE platform 36 (2) and the on-air event raw data is sent to the data center 30 (3). The raw on-air data is then compared in the storage units 35 by the application layer (4) and enriched interactive radio data is generated (examples of which are described below) by the application layer and output (5) and the data processor 37 passes the enriched data onto the TRE system 36 (6). The TRE may then distribute the enriched data to the hardware of the radio station (7) and then the media players 14, websites and other enriched interactive radio data enabled devices provide a rich user experience (8) based on the enriched interactive radio data.

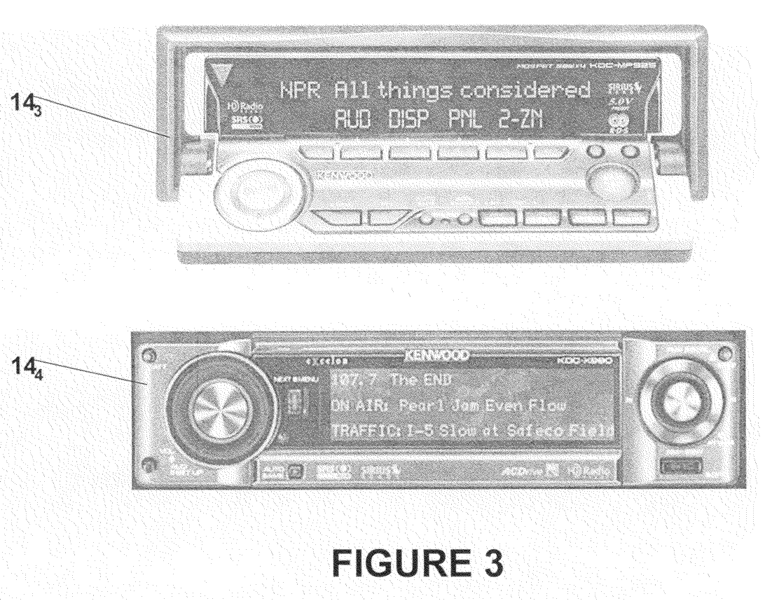

FIG. 3 illustrates two examples of media devices that include data from the interactive radio system. The two exemplary media devices may include a HD radio receiver 143 and an RDS with RT+ receiver 144. In the HD radio receiver 143, the enriched interactive radio data may permits a rolling test display of the enriched interactive radio data. In the RDS with RT+ receiver 144, the enriched interactive radio data can provide three lines of textual information including, in this example, a station frequency and name in a first line, an artist and title of the current song in the second line and a miscellaneous data such as a traffic report in the third line.

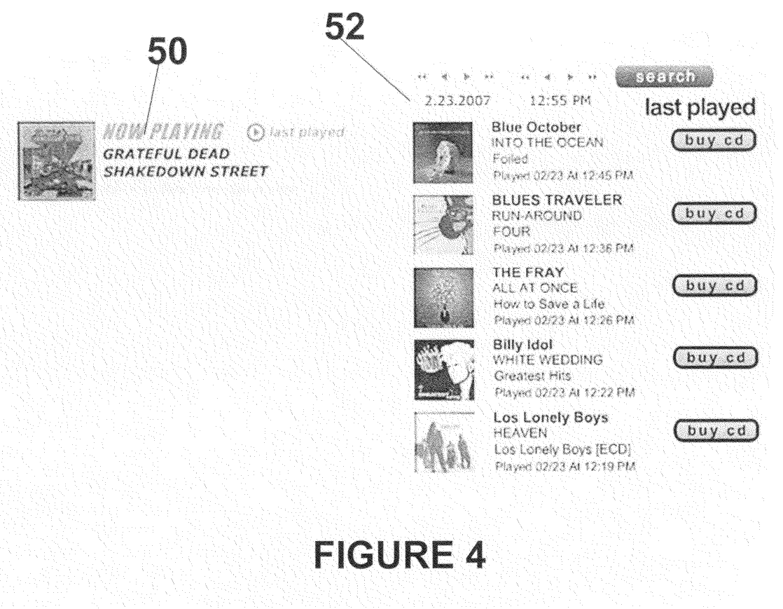

FIG. 4 illustrates an example of a display aspect of the interactive radio system wherein the enriched interactive radio data may be used to provide music synchronization with artist, title and album information. An example of a display 50 that may appear on a media device with a limited screen is shown along with an example of a display 52 for a media device with a larger screen. In both cases, the display permits the user to buy one or more of the songs (or CDs) recently played by the radio station so that the radio station can provide the user with a list of the recently played songs and albums to enrich the user listening experience and derive revenue from the sale of the song or CD.

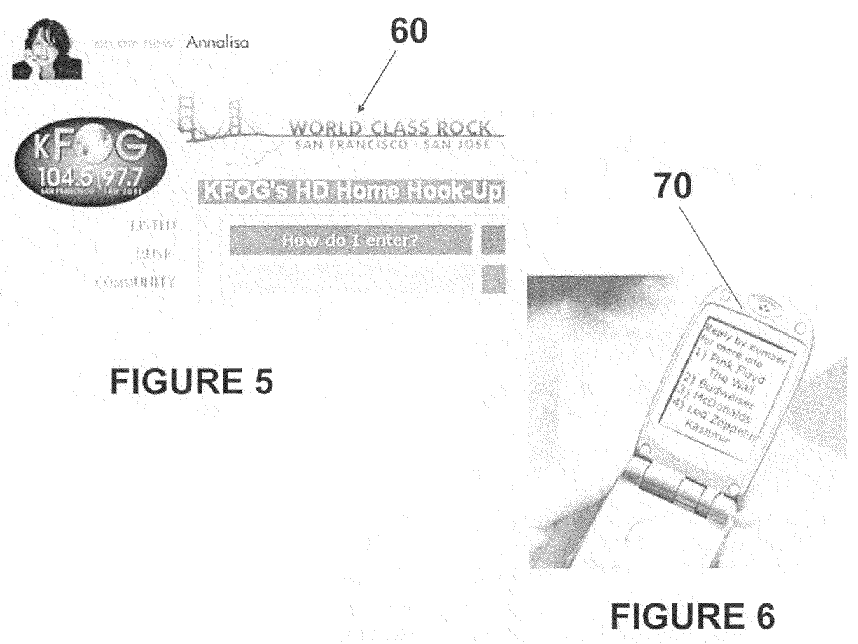

FIG. 5 illustrates an example of an elements aspect of the interactive radio system in which the enriched interactive radio data may be used to display a user interface 60 that may include a station promotion, a current announcer/show title or an event or time of day information. For the elements aspect, the system may provide a web interface for each radio station customer to manage the information sent to the users by the element aspect of the system.

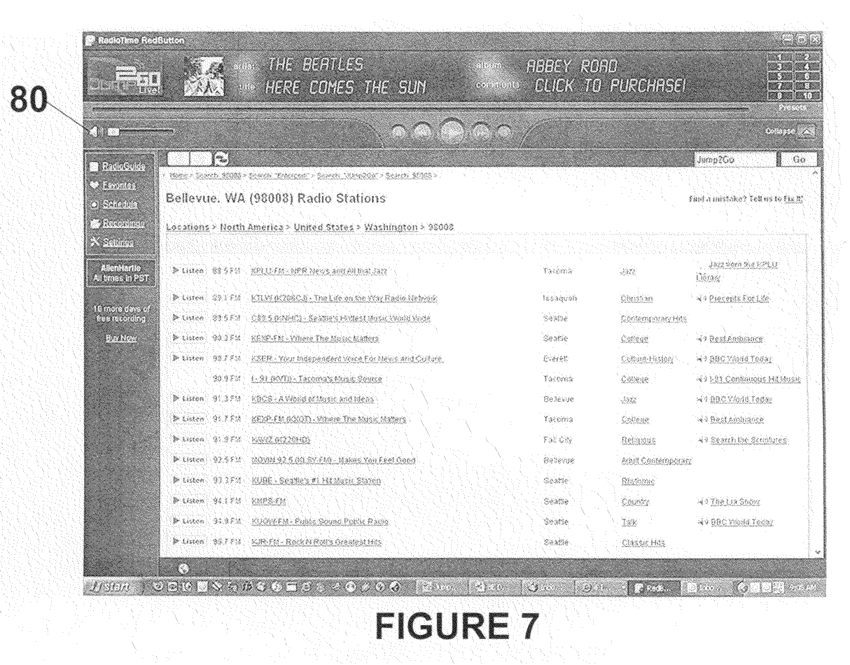

FIG. 6 illustrates an example of a mobile aspect of the interactive radio system in which the system, using the enriched interactive radio data, may generate a display 70 on a mobile device, such as a cellular phone. In one example, the user can send a message to the station, receive a history of the on-air events as an interactive SMS message and reply by menu number to receive additional information about a particular song or album.

FIG. 7 illustrates an example of an electronic program guide aspect of the interactive radio system in which the interactive radio system can generate a display 80 of an electronic programming guide (EPG) and an EPG service bureau that is applicable to HD radio, RDS, web applications and device manufacturers.

The interactive radio system also may provide an advertising aspect, a web community aspect using SMS messages, conditional real-time replace for message text, integration with an ecommerce partner and data services. In the advertising aspect, the system may provide synchronized advertiser text and images, an enhanced web interface for event synchronization management and interactive SMS. The data services may include the integration of other data such as weather information, traffic information (See FIG. 3 for example), ESPN sports headlines and scores and/or music news.

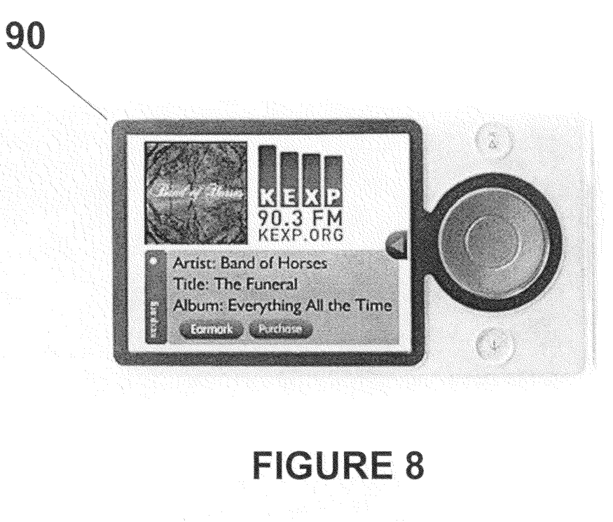

FIG. 8 illustrates an example of a mobile media device that implements the interactive radio system wherein the mobile media device 90 is the recently introduced Microsoftg Zune device. The interactive radio system may permit album artwork, station logo and graphics, artist/title/album/comments, an electronic program guide (EPG), bookmarks for favorite songs with the bookmarks linked to purchase options (when the device is docked) to be displayed to the user as shown in FIG. 8. The system may embed the Zune product IDs in the RDS stream, embed encrypted EPG data into the RDS stream, timestamp Zune user interactions and cache metadata to give the Zune user the illusion of connectedness.

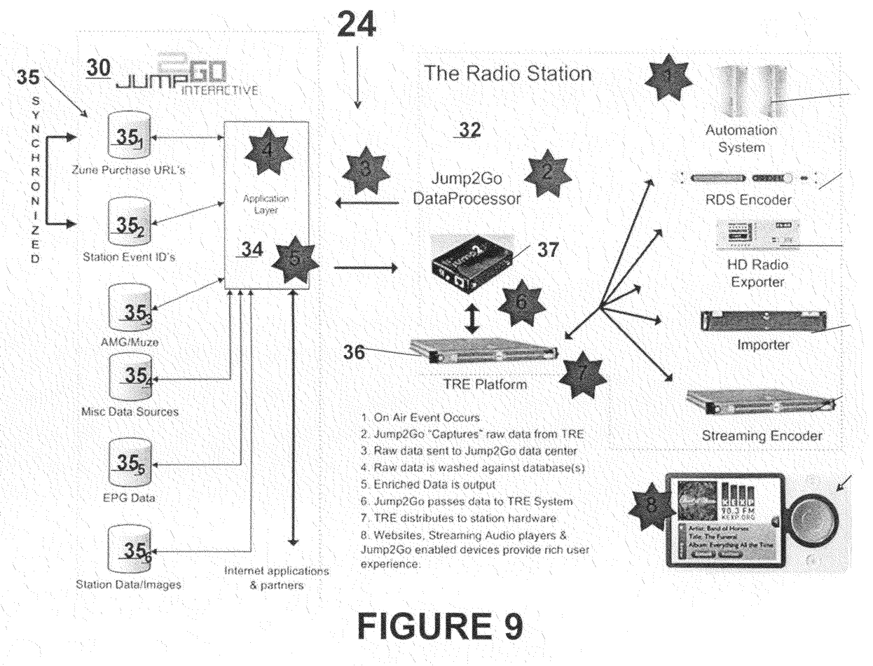

FIG. 9 illustrates the interactive radio system with the mobile media device 90 which is the same system shown in FIG. 2 that operates in a similar manner. For the Zune device, the Zune purchase IDs 35₁ and the station event IDs 35₂ are synchronized with each other.

In summary, the system provides a system and method for synchronizing the radio station on-air events with text messages and images on radio receivers and portable media devices that incorporate visual displays and Internet connectivity. By “indexing” each on-air event, and coordinating a database of text, images, and product purchase ecommerce links, the textual information and unique on-air-event ID's can be broadcast at the same time the audio is broadcast, creating a rich information & multimedia experience for radio consumers. At the same time visual content is present, purchase opportunities are made available. The information can be directly displayed on the radio display, or the receiver design may “capture” the Unique on-air-eventID, and use connectivity to lookup the ID, and then display a rich presentation for the listener. Some receivers may use a button on the device to “bookmark” the on-air-eventID, this captured ID is used at a later point in time when connectivity is present to then do the lookup against the metadata database.

While the foregoing has been with reference to a particular embodiment of the invention, it will be appreciated by those skilled in the art that changes in this embodiment may be made without departing from the principles and spirit of the invention, the scope of which is defined by the appended claims.

1. An interactive radio method, comprising:
capturing an on-air event from a radio station;
generating a set of enriched interactive radio data pieces associated with the on-air event;
transmitting the set of enriched interactive radio data pieces associated with the on-air event to a media device so that the on-air event is synchronized with the set of enriched interactive radio data pieces; and
displaying one or more of the enriched interactive radio data pieces on the media device so that a listening experience of the user of the media device for the radio station.

2. The method of claim 1, wherein the enriched interactive radio data pieces further comprises a textual message.

3. The method of claim 1, wherein the enriched interactive radio data pieces further comprises a graphical image.

4. The method of claim 1, wherein the media device further comprises a radio receiver.

5. The method of claim 1, wherein the media device further comprises a portable media device.
